(19) United States
(12) Patent Application Publication
(10) Pub. No.: US 2026/0101091 A1
(43) Pub. Date: Apr. 9, 2026

(54) SYSTEM USING CONTEXTUAL INFORMATION TO ENHANCE RELEVANCE OF SUPPLEMENTAL CONTENT TO PROGRAMMED CONTENT

(71) Applicant: ANOKI INC., San Carlos, CA (US)

(72) Inventors: Ashish Baldua, San Jose, CA (US); Ravi Sarma, Highlands, NJ (US); Susmita Ghose, Mountain View, CA (US); Sri Krishna Velivela, Bellevue, WA (US)

(73) Assignee: ANOKI INC., San Carlos, CA (US)

(21) Appl. No.: 18/907,330

(22) Filed: Oct. 4, 2024

(51) Int. Cl. H04N 21/81

(52) U.S. Cl. CPC H04N 21/8133; H04N 21/812

(57) ABSTRACT

A content processing system may include a program scheduler connected to a content streaming platform. The program scheduler receives EPG information from the content streaming platform, an EPG database connected to the program scheduler containing channel identification, program start time, content identification assigned by the program scheduler, a content metadata database containing content source information, content length, and contextual information regarding the program including an aggregated embedding generated by multimodal metadata extraction from the content of the program. The content source information, the content length, and the contextual information are indexed by the content identification. The system may include a context analysis unit for generating the aggregated embedding having a content input connecting the program to the context analysis unit and an output connected to the content metadata database to store the aggregated embedding as the contextual metadata. The program scheduler may be connected to activate the context analysis unit.

### CROSS-REFERENCE TO RELATED APPLICATIONS

This application is related to U.S. application Ser. No. 18/581,328 filed on Feb. 19, 2024, attorney docket no. 169003; U.S. application Ser. No. 18/581,329 filed on Feb. 19, 2024, attorney docket no. 169004; U.S. application Ser. No. 18/581,330 filed on Feb. 19, 2024, attorney docket no. 169005; U.S. application Ser. No. 18/581,3232 filed on Feb. 19, 2024, attorney docket no. 169006; U.S. application Ser. No. 18/581,333 filed on Feb. 19, 2024, attorney docket no. 169007; U.S. application Ser. No. 18/581,334 filed on Feb. 19, 2024, attorney docket no. 169008; U.S. application Ser. No. 18/581,335 filed on Feb. 19, 2024, attorney docket no. 169009; and U.S. application Ser. No. 18/581,336 filed on Feb. 19, 2024, attorney docket no. 169010 the disclosures of all of which are incorporated by reference herein.

### BACKGROUND OF THE INVENTION

### 1. Field of the Invention

The invention relates to a video content processing system and more particularly to contextual selection of supplemental content.

### 2. Description of the Related Technology

Online advertising is a form of marketing and advertising that uses the Internet to promote products and services to audiences and platform users. Advertisements are increasingly being delivered via automated software systems operating across multiple websites, media services, and platforms, known as programmatic advertising.

Online advertising may also be delivered by a provider who integrates advertisements into its content streamed or otherwise delivered, and an advertiser who provides the advertisements to be displayed on or with content from the provider. Other potential participants include advertising agencies that help generate and place an advertisement, and an ad server that delivers and tracks the advertising activity. Advertisements may be supplemental content.

The advertising process of delivering supplemental content with a programmed channel may involve many parties. In the simplest case, the content provider selects and serves the supplemental content (ads). Alternatively, ads may be outsourced to an advertising agency, and served from the advertising agency's servers or ad space may be offered for sale in a bidding market using an ad exchange and real-time bidding, known as programmatic advertising.

Programmatic advertising involves automating the sale and delivery of digital advertising on a content channel via software rather than direct human decision-making. Advertisements are selected and targeted to audiences via ad servers which often use cookies, which are unique identifiers of specific computers, to decide which ads to serve to a particular consumer. Cookies can track whether a user left a page without buying anything, so the advertiser can later retarget the user with ads from the site the user visited.

Digital Platforms Inquiry, Final Report June 2019, Australian Competition and Consumer Commission, ISBN 978 1 920702 05 2, https://itlaw.fandom.com/wiki/Digital_Platforms_Inquiry-Final_Report, (accessed Mar. 25, 2024) the disclosure of which is expressly incorporated by reference herein, focusses on the three categories of digital platforms identified in the Terms of Reference: online search engines, social media platforms, and other digital content. Many of the concepts and disclosures apply to or can be adapted to the field of this invention and specifically the field of selection and delivery of secondary content relevant to primary content. Some of those concepts are:

An ad network is a network that purchases digital advertising inventory and repackages and sells these opportunities to advertisers directly or through Ad exchanges.

Ad tech is a common abbreviation for ‘advertising technology’. It refers to intermediary services involved in the automatic buying, selling, and serving of some types of advertisements.

An Ad tech stack is a common abbreviation for ‘advertising technology stack’. It refers collectively to the combination of ad tech involved in the advertising supply chain between advertisers and content suppliers. For example, this may include DSPs, SSPs, ad servers, and ad exchanges.

Digital content aggregation platforms are online intermediaries that collect information from disparate sources and present some or all of such information to certain consumers as a collated, curated product. Such consumers may be able to customize or filter their aggregation, or to use a search function. Examples of digital content aggregation platforms include Google News, Apple News, and Flipboard. Digital content aggregation platforms may also be accessed or incorporated into a DSP or an SSP.

DSP is an abbreviation for Demand Side Platform—a platform used by advertisers to optimize and automate the purchase of advertising opportunities.

SSP is an abbreviation for Supply Side platform—a platform used to optimize and automate the sale of online advertising inventory.

Artificial intelligence (AI) is the intelligence of machines or software, as opposed to the intelligence of human beings or animals. Machine learning is the study of programs that can improve their performance on a given task automatically. It has been a part of AI from the beginning.

There are several kinds of machine learning. Unsupervised learning analyzes a stream of data, finds patterns, and makes predictions without any other guidance. Supervised learning requires a human to label the input data first and comes in two main varieties: classification (where the program must learn to predict what category the input belongs in) and regression (where the program must deduce a numeric function based on numeric input). In reinforcement learning the agent is rewarded for good responses and punished for bad ones. The agent learns to choose responses that are classified as “good”. Transfer learning is when the knowledge gained from one problem is applied to a new problem. Deep learning uses artificial neural networks for these types of learning.

Natural language processing (NLP) allows programs to read, write, and communicate in human languages such as English. Specific problems include speech recognition, speech synthesis, machine translation, information extraction, information retrieval, and question answering.

Modern deep learning techniques for NLP include word embedding (how often one word appears near another), transformers (which find patterns in text), and others. Feature detection helps AI compose informative abstract structures out of raw data.

Machine perception is the ability to use input from sensors (such as cameras, microphones, wireless signals, active lidar, sonar, radar, and tactile sensors) to deduce aspects of the world. Computer vision is the ability to analyze visual input. The field includes speech recognition, image classification, facial recognition, object recognition, and robotic perception.

Deep learning uses several layers of neurons between the network's inputs and outputs. The multiple layers can progressively extract higher-level features from the raw input. For example, in image processing, lower layers may identify edges, while higher layers may identify the concepts relevant to a human such as digits, letters, or faces.

Generative artificial intelligence (AI) is artificial intelligence capable of generating text, images, or other media, using generative models. Generative AI models learn the patterns and structure of their input training data and then generate new data that has similar characteristics. A generative AI system is constructed by applying unsupervised or self-supervised machine learning to a data set. The capabilities of a generative AI system depend on the modality or type of the data set used.

A foundation model (also called base model) is a large machine learning (ML) model trained on a vast quantity of data at scale (often by self-supervised learning or semi-supervised learning) such that it can be adapted to a wide range of downstream tasks. Foundation models can in turn be used for task and/or domain-specific models using targeted datasets of various kinds. Beyond text, several visual and multimodal foundation models have been produced—including DALL-E, Flamingo, Florence, and NOOR. Visual foundation models (VFMs) have been combined with text-based LLMs to develop sophisticated task-specific models. There is also Segment Anything by Meta AI for general image segmentation. For reinforcement learning agents, there is GATO by Google DeepMind.

Foundation models may be further developed through additional training. A foundation model is a “paradigm for building AI systems” in which a model trained on a large amount of unlabeled data can be adapted to many applications. Foundation models are “designed to be adapted (e.g., finetuned) to various downstream cognitive tasks by pre-training on broad data at scale”.

Key characteristics of foundation models are emergence and homogenization. Because training data is not labeled by humans, the model emerges rather than being explicitly encoded. Properties that were not anticipated can appear. For example, a model trained on a large language dataset might learn to generate stories of its own or to do arithmetic, without being explicitly programmed to do so. Furthermore, these properties can sometimes be hard to predict beforehand due to breaks in downstream scaling laws. Homogenization means that the same method is used in many domains, which allows for powerful advances but also the possibility of “single points of failure”.

### SUMMARY OF THE INVENTION

It is an object to provide a system that uses contextual information from primary content to increase the relevance of secondary content to the primary content. The primary content may be a user-selected content stream such as a FAST Channel Program. The secondary content may be an advertisement.

It is a further object to provide a system that may utilize contextual information to facilitate the selection of secondary content with enhanced relevance to primary content on the supply side of an advertisement stack.

It is a further object to provide a system that may utilize contextual information to facilitate selection of secondary content with enhanced relevance to primary content on the demand side of an advertisement stack.

According to a feature, the system may be capable of indexing content, including video and/or other content, according to multiple domains. According to a further feature, the system may index video on a scene-by-scene basis and/or a frame-by-frame basis. The other content may include, without limitation, audio or closed captioning.

It is an object to provide a system that utilizes a deep understanding of video content to provide contextual advertising. Contextual advertising is more relevant to the content and thus likely to be more relevant to a user who elects to view the content. Contextual advertising is more effective than advertising untethered to the content and thus more valuable to the advertiser.

It is an object to provide a system that can enrich content, using rich metadata, may provide the viewer with an enhanced viewing experience. This increases engagement. The ability to understand the content being consumed by a viewer enables the presentation of secondary content in the form of recommendations of similar content or in the form of advertisements that enhance advertiser value propositions for increased monetization. This can provide better fill rates and higher CPMs for advertisement placements.

An example of utilizing the system for contextual advertising:

Consider a user who is watching content with a high-speed car chase. The advertising provided immediately following the car chase scene can be selected to be consistent with the scene. For example, an advertisement may be presented for a sports car immediately following a high-speed chase. The selection of a Porsche advertisement immediately for placement after a high-speed car scene involving a Porsche is even more relevant.

The enriched metadata may also indicate that the high-speed chase involving a Porsche ends in a fiery crash in which case it may be better for an agency placing Porsche advertisements to know that would be an inopportune moment to place a Porsche advertisement. Instead, it may be more opportune to provide a message relating to car safety.

For another example, when the content viewed relates to an infant, it may be appropriate to show an advertisement for relevant products such as car seats, diapers, baby formula, or other baby-related items.

For another example, restaurant advertisements may be served following content showing people dining in a restaurant. Similarly, insurance ads may be served following content showing natural disasters or other types of destruction.

The foregoing examples involve the presentation of an advertisement during a pre-established commercial break in the content provided or by interrupting the content at an appropriate juncture during the consumption of content. The system may use a deep understanding of the content reflected in the rich metadata to determine the point in the presentation of content to present an advertisement. For example, at the conclusion of a scene or the conclusion of a shot. The system also has the ability to understand the frequency and timing of commercial breaks and override scheduling based on determined conditions. For example, the system may accommodate logic to override an advertisement opportunity determined based on the content but is otherwise inappropriate or undesirable, for example, based on time constraints such as the opportunity following too closely after another opportunity.

Another modality for the use of the system is to modify the content by superimposing relevant messages in an automated fashion based on a deep understanding of the content reflective of the metadata which, in turn, is reflective of the scene. For example, during a scene that includes a baby smiling or otherwise expressing joy, an overlay may be provided to the content with a consistent advertising message. For example, “This happy baby moment is brought to you by Huggies”. According to another example where content shows a relaxing moment with folks sitting around a fire, a pool, or in a lounge, the message may be “This moment is brought to you by Bud Light”.

A deep understanding of the content can facilitate the presentation of the overlay. This can be accomplished by deciding if there is a suitable position on the screen during a shot for presenting the overlay. This involves a determination of a sufficiently sized area with a relatively low level of variations for a sufficient period of time during or near the relevant portion of the content. The rich metadata can also assist in selecting the color of the superimposed message. For example, the superimposed message should not be presented over content having similar coloring as the backdrop. The system may use AI techniques to alter the coloring of the superimposed image or to select an image to superimpose that has contrasting coloring to the backdrop. The system may also interface with an ad server and include in the identification of an ad opportunity, the particulars (size shape, background color, duration, and information describing the content) as part of a bid package, and the ad server may place advertisements through a competitive bid process where the advertiser/agency controls the bids and advertisement selection based on the particulars. The advertiser may thereby elect to limit the superimposition based on the particular colors. For example, Coca-Cola may have superimposed content in two versions: according to one version the superimposition is in red, and according to another version, the superimposition is white. Each may be suitable only for a limited range of background colors and the background color will inform the decision to place a particular advertisement superimposed on the content.

According to an advantageous feature, a multimodal metadata extraction system may be provided with a scene detector having a video content input and an output representing scene boundaries. The metadata extractor may use the scene boundaries as defining a scene and be responsive to the content of the scene defined by the scene boundaries to extract metadata corresponding to several, plural, or multiple extraction modes. A metadata embedding may be used for each of the modes.

An embedding aggregator responsive to the embedding may operate to formulate an aggregated embedding for each scene thereby indexing the content of the scene. The output representing the identified scenes may be a set of video clips of each scene or an index to the video content corresponding to the identified scenes. The scene detector may include a frame analyzer for identifying consecutive frames having similar characteristics. A boundary detector may be provided to identify boundaries of consecutive frames having sufficiently similar characteristics that they likely belong to the same shot. An embedding system may be provided to formulate a composite distance matrix capturing the distance between shot embeddings. A temporal clustering system may be connected to the composite distance matrix. An output of the temporal clustering system identifies the scene boundaries of the content.

An embedding database may be connected to the embedding aggregator for storing the aggregated embedding for use as a search index for scenes identified in the content.

The multimodal metadata extraction system may be provided with extraction modes to adequately characterize the content. The particular extraction modes and several extraction modes may be by the application for which the metadata will be used. Extraction modes include at least one of audio (speech recognition, music recognition); image recognition (feature recognition with temporal understanding); text (caption, scene summarization, text recognition); and scene interpretation (sentiment, profanity, action level). Many other extraction modes may be implemented.

A system for contextual modification of content based on multimodal extraction of metadata from the content, wherein said metadata is extracted by processing one or more scenes in said content to extract metadata corresponding to multiple extraction modes, and an embedding model for each extraction mode wherein an aggregated embedding model responsive to said extracted metadata for each mode formulates an aggregated embedding including a process controller having an embedding extractor responsive to a control input wherein the control input specifies one or more features defining a content modification opportunity and wherein the embedding extractor includes an embedding model coordinated with the embedding model for one or more of the embedding modes to generate an opportunity embedding in the form of a vector. A vector comparison processor for determining the distance between the opportunity embedding and the aggregated embedding to determine a content modification opportunity. Wherein the process controller is responsive to the vector comparison processor to generate edit control instructions indicating a modification of the content upon detection of the content modification opportunity. A content editor is responsive to the edit control instructions to modify the content and have a modified content output.

The edit control instructions may cause the content editor to add an overlay to the content. A creative library to store one or more content overlays and the edit control instructions may specify an overlay for use by said content editor.

The edit control instructions may include an identification of an overlay stored in the creative library and the content editor may be connected to the creative library. The edit control instructions may include the overlay and the process controller may be connected to the creative library. The edit control instructions may include instructions for placement of the overlay in the modified content output.

The edit control instructions may include instructions for modification of the overlay in the modified content. The process controller may be responsive to the vector comparison processor to identify an indication of the position and duration of a content modification opportunity and may further include a modification selection server responsive to the opportunity to select a modification to apply to said content. The modification selection server may be a competitive bid processor.

The edit control instructions may cause the content editor to interrupt the content and add a set of additional frames to the content during the interruption. A creative library may store one or more sets of additional frames and the edit control instructions may specify a set of additional frames for use by the content editor.

The edit control instructions may include an identification of a set of additional frames stored in the creative library and the content editor may be connected to the creative library. The edit control instructions may include the set of additional frames and the process controller may be connected to the creative library. The edit control instructions may include instructions for placement of the set of additional frames in the modified content output. The process controller may be responsive to the vector comparison processor to identify the time of insertion of the set of additional frames.

The process controller may be responsive to the vector comparison processor to identify the location of a content modification opportunity and a modification selection server responsive to the opportunity to select a modification to apply to said content. The modification selection server may be a competitive bid processor.

The system may utilize one or more of the modalities and processes described in U.S. patent applications Ser. No. 18/581,328; Ser. No. 18/581,329; Ser. No. 18/581,330; Ser. No. 18/581,332; Ser. No. 18/581,333; Ser. No. 18/581,334; Ser. No. 18/581,335; and Ser. No. 18/581,336 to utilize contextual information describing primary content such as a FAST Channel Program to select secondary content such as an advertisement with enhanced relevance to the primary content.

A method for utilizing a deep understanding of content to select secondary content including the steps of issuing an aggregated embedding generated by multimodal metadata extraction from a primary content stream, comparing the aggregated embedding to metadata corresponding to secondary content generated by multimodal metadata extraction from the secondary content, and selecting secondary content based on the step of comparing the aggregated embedding to metadata corresponding to the secondary content. The method may include the steps of identifying an advertising opportunity in the primary content and issuing a bid request for the advertising opportunity wherein the bid request includes identification of the advertising opportunity and the aggregated embedding.

A content processing system may include a program scheduler connected to a content streaming platform wherein the program scheduler receives electronic program guide information from the content streaming platform, an electronic program guide database connected to the program scheduler containing channel identification program start time information, and a content identification assigned by the program scheduler, and a content metadata database containing content source information, content duration, and contextual information regarding the program including an aggregated embedding generated by multimodal metadata extraction from the content of the program wherein the content source information, the content duration information, and the contextual information are indexed by the content identification assigned by the program scheduler. The content processing system may further include a context analysis unit for generating an aggregated embedding by multimodal metadata extraction having a content input connecting the program to the context analysis unit and having an output connected to the content metadata database and configured to store the aggregated embedding as the contextual metadata. The program scheduler may be connected to activate the context analysis unit. The program scheduler may be configured to activate the context analysis unit if it determines that the content metadata database does not have contextual metadata stored for a program identified by the electronic program guide information.

A supply-side advertising server may be connected to the content streaming platform wherein the supply-side advertising server may receive an advertisement request including a channel identification from the content streaming platform and provides an advertisement responsive to the advertisement request to the content streaming platform. A contextual advertisement server platform may be connected to the supply-side advertising server, wherein the contextual advertisement server platform receives an advertisement request including a channel identification from the supply-side advertising server, and the contextual advertisement server platform uses the channel identification to retrieve contextual metadata from the context metadata database. The content processing system may include a demand-side advertisement server connected to the contextual advertisement server platform to receive contextual metadata for use in identifying a responsive advertisement based on the contextual metadata. The contextual advertisement server platform may be implemented in a supply-side or a demand-side platform.

Various other objects, features, aspects, and advantages of the disclosed system will become more apparent from the following detailed description of preferred embodiments of the invention, along with the accompanying drawings in which the same numerals represent the same components across more than one figure.

Moreover, the above objects and advantages are illustrative, and not exhaustive, of those that can be achieved by the or with the system. Thus, these and other objects and advantages will be apparent from the description herein, both as embodied herein and as modified because of any variations that will be apparent to those skilled in the art.

### BRIEF DESCRIPTION OF THE DRAWINGS

FIG. 1 shows a multimedia metadata extraction system.

FIG. 2 shows the operation of a scene detector.

FIG. 3 shows a system architecture for taking advantage of a deep understanding of content.

FIG. 4 shows a schematic of a contextual metadata extraction system.

FIG. 5 shows a schematic of the system delivering program content which utilizes a contextual demand side platform.

FIG. 6 shows a contextual ad gateway integrated into a supply-side platform.

### DETAILED DESCRIPTION OF THE PREFERRED EMBODIMENT

Before the present invention is described in further detail, it is to be understood that the invention is not limited to the embodiments described, as such may, of course, vary. It is also to be understood that the terminology used herein is for the purpose of describing embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of exemplary methods and materials are described herein.

It must be noted that as used herein and in the appended claims, the singular forms “a”, “an”, and “the” include plural referents unless the context dictates otherwise.

All publications mentioned herein are incorporated herein by reference to disclose and describe the methods and/or materials in connection with which the publications are cited. The publications discussed herein are provided solely for their disclosure before the filing date of the present application. Nothing herein is to be construed as an admission that the present invention is not entitled to antedate such publication by prior invention. Further, the dates of publication provided may be different from the actual publication dates, which may need to be independently confirmed.

A system is provided for processing video content to gain a rich understanding of the video content. To effectively process the content and achieve sufficient computational efficiency, even using artificial intelligence (AI) techniques, a content stream may be divided into scenes made up of one or more segments of the content. Each segment is likely to correspond to a shot and is made up of one or more sequential frames having a high level of commonality. Two or more segments having a high level of commonality may be grouped together and processed as a single scene.

In content production, a “shot” is typically considered to be a continuous view captured by a single camera without interruption. A processor can identify continuous frames that are likely to be in the same groups of frames in a shot by examining local color distribution. These shots are identified as a segment of content. Similar shots (or segments) may be grouped into scenes. Similar shots are taken to be part of a scene. Shots having sufficient similarity in a scene are assumed to convey a homogeneous storyline or concept.

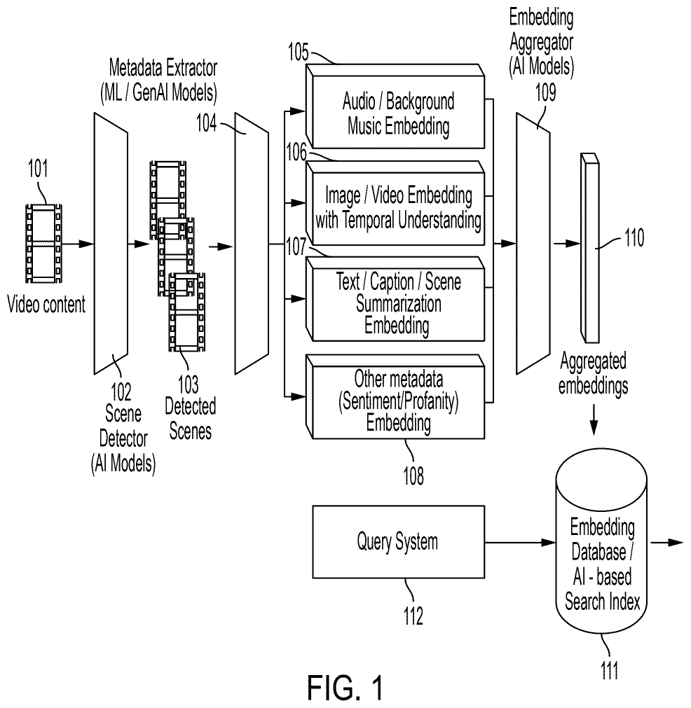

FIG. 1 shows a multimodal metadata extraction system with a video content input 101. The content input 101 is provided to a scene detector 102. The scene detector 102 operates to break a video content stream to smaller (or shorter) scenes. A video stream is made up of a series of frames. Frames of content can be grouped into segments based on commonality. Segments can also be grouped into scenes based on commonality.

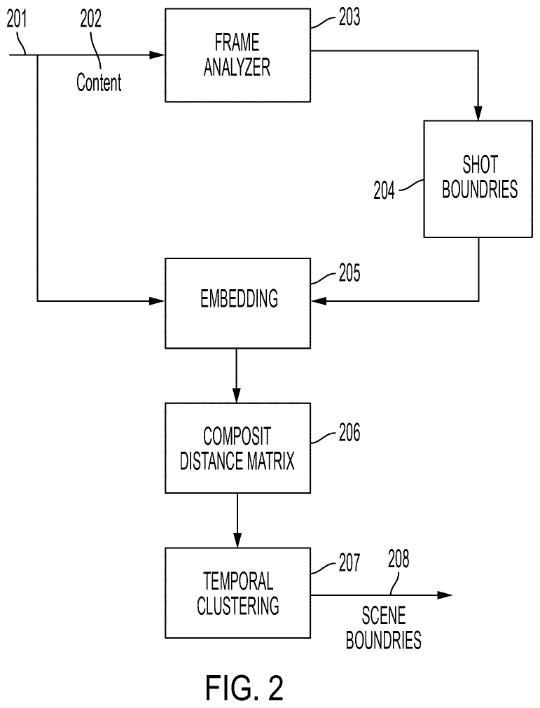

FIG. 2 shows the operation of scene detector 102. A content stream is provided to a stream analyzer for performing a frame-by-frame analysis to identify boundary frames for a series of consecutive frames having a high level of similarity. The frame-by-frame analysis may be performed by using significant average color distribution differences between consecutive frames. The shot boundaries may be stored in boundary table 204 and used to access the frames of a shot. The video content may be in content storage 206. Alternatively, the frames of a shot may be processed in a stream.

The frames of the shots are provided to embedding system 205. The embedding system may be implemented using a convolutional neural network or a Vision Transformer based on a Deep Learning image featurizer. The embedding system may generate a composite distance matrix 206 by capturing the distance between shot embedding based on a distance metric and potentially the temporal distance between shots.

Temporal clustering 207 based on dynamic programming is applied on the composite distance matrix 206 to group similar, shots together to obtain scene boundaries 208.

Scene boundaries 208 define the detected scenes 103. The detected scenes 103 are provided to a metadata extractor 104. The metadata extractor 104 considers the content of the scenes individually according to selected aspects anticipated to be potentially present in the content. FIG. 1 illustrates four aspects for processing and embedding. The aspects illustrated in FIG. 1 are examples, Audio/Background Music embedding 105, Image/Video embedding with temporal understanding 106, Text/Caption/Scene Summation embedding 107, and other metadata (sentiment profanity) 108. In practice, many more modes are contemplated. For example, location, time of day, weather, genre, etc.

The extraction frame level detail may include objects, logos, locations, sentiment, action detection, scene summarizer, etc. All the information is then encoded using an embedding model for every scene and a vector search index for each scene is then built. This allows for free-form, contextual, and detailed video indexing/searches for example the metadata for “a romantic scene with a glass of wine by a lake” can be easily identified.

The embeddings are provided to an embedding aggregator 109 to generate aggregated embeddings 110. The aggregated embeddings may be stored in an embedding database 111.

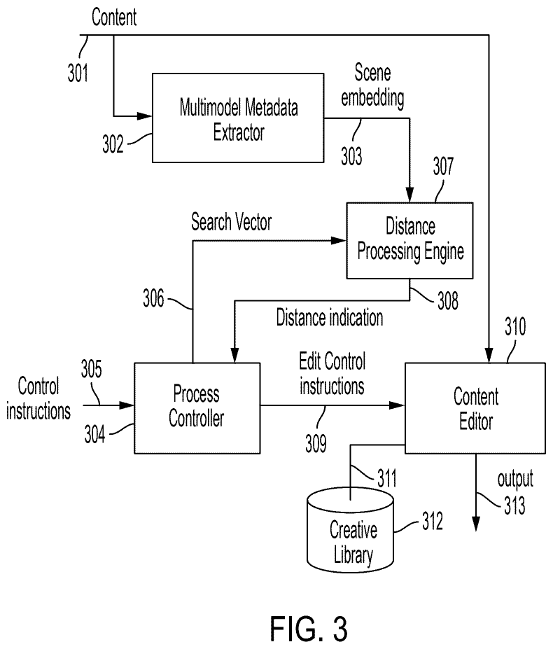

FIG. 3 shows a system architecture for taking advantage of a deep understanding of content, including video and/or other content. Video or other content of 301 is provided to the system. Depending on the application, architecture, and demands in terms of computational complexity and timing, all data processed through the system may be in the form of a data stream or may be stored, accessed, and used by the system as needed. The system may be implemented in a hybrid approach whereby processing is performed as demanded with results stored in buffers. In this manner, processing need not be synchronized with content output requirements. The system may utilize libraries and databases to preprocess and store content, including subject video content, operational parameters, and creatives, which are used to modify video content processed by the system. The video or other content 301 may originate from a database or content library or be a video stream.

The multimodal metadata extractor develops data serving as an index representing a deep understanding of the video content. An embodiment of the multimodal metadata extractor 302 is illustrated in FIG. 1 and described in connection therewith. The multimodal metadata extractor 302 outputs scene embeddings 303 generated by artificial intelligence processing techniques. The scene embeddings 303 are associated with the video or other content 301 processed by the multimodal metadata extractor 302. The association may, for example, be affected by video or other content 301 timestamps indexed against or incorporated into the scene embeddings 302. Alternatively, the scene embeddings 303 may be combined with the video or other content 301. The process controller 304 is illustrated schematically in FIG. 3. The process controller 304 may have different configurations depending on the intended application of the system. Embodiments of the process controller 304 are described hereinafter. Process control instructions 305 are provided to process controller 304. The process control instructions 305 may be generated manually or, particularly in a production environment, generated in an automated fashion. The process controller 304 may have a search vector output 306. The search vector output 306 may be generated based in part on process control instructions 305. The process controller 304 may be configured with inputs in the form of text or other queries. Alternatively, or in addition, the process controller may be configured with inputs in the form of media content queries and having a metadata extractor with one or more embeddings. If more than one embedding is extracted, an embedding aggregator may be included to generate an aggregated search vector.

The process controller 304 may generate an output of one or more search vectors 306. The search vector(s) 306 is provided to distance processing engine 307. The distance processing engine 307 may determine the distance between the search vector 306 and relevant portions of the scene embeddings 303. In many applications, an identical match between a search vector 306 and scene embeddings 303 is not necessary, and indeed is not expected. A match is indicated when the distance between the search vector 306 and the relevant aspects of scene embeddings 303 falls below a threshold. The threshold may be set to a default level or may be provided and/or modified as part of the control instructions 305.

The distance processing engine 307 has an output 308 connected to the process controller 304. The output 308 of the distance processing engine may represent a distance between a search vector 306 and scene embeddings 303. In this case, the process controller 304 may determine if a threshold distance is satisfied. Alternatively, the distance processing engine 307 may compare the distance to a threshold and issue a determination indicating whether the threshold is satisfied at output 308 to process controller 304. Depending on the control instructions 305 and the distance processing engine output 308, the process controller 304 provides edit control instructions 309 to a video content editor 310. The video content editor 310 may alter the video content following the content instructions 309.

According to an embodiment, the video content editor 310 may be responsive to an ad network to provide an edit control instruction 309 to specify creative material or include instructions to retrieve creative content 311 from a creative library 312. The creative content 311 may be supplemental information to modify the video or other content 301 by the video content editor 310 to generate a video output 313. The output 313 may be streamed for consumption or stored for later consumption. According to one embodiment, the edit control instructions 309 may include creative material or include instructions to retrieve creative content 311 from a creative library 312. According to a hybrid approach, the video content editor 310 does not modify the video or other content 301 strictly in sequential order.

An example of the aforementioned hybrid approach may be a system where the video content editor 310 does not modify the video or other content 301 strictly in sequential order. Such a situation may occur if temporal clustering is utilized and all similar scenes by modification are modified together thereby causing the remaining scenes to be processed out of sequential order. In such situations, the processed video may be accumulated in a buffer and output from the buffer in sequential order. Such an operation may result in computational efficiencies.

The insertion of contextual advertising may be accomplished by an embodiment shown in FIG. 3. An advertiser or agency may submit control instructions 305 to the process controller 304. The process controller 304 may formulate a search vector 306 based on the control instructions. For example, the search vector may be designed to identify a commercial break in content suitable for the insertion of a Porsche advertisement. In this case, the control instructions would be to formulate a search vector representation of a high-speed chase involving a Porsche having a positive result for the Porsche (escape or first-place finish and not ending in a crash of the Porsche). The search vector 306 is compared to scene embeddings 303 by the distance processing engine 307. If the distance is below a threshold level, a threshold match indication 308 may be provided to the process controller 304 which then issues edit control instructions 309 to the video content editor 310. The video content editor 310 may retrieve a selected advertisement 311 from the creative library. The video content editor 310 may then insert the Porsche advertisement 311 retrieved from the creative library 312 into the video or other content 301 to be included in the commercial break in the video or other content 301 and incorporated into output stream 313. Generally, this example identifies a suitable advertising opportunity and then modifies the video content to include additional creative materials i.e., the advertisement in the video stream.

The above-described process for overlaying an ad or sponsorship into video content is performed in essentially the same manner except that the creative 311 retrieved from the creative library 312 is superimposed over the video or other content 301 by video content editor 310 and incorporated into the video content output stream 313 when the when an advertising opportunity consistent with control instructions 305 is identified.

According to an embodiment, the system may be integrated with existing advertisement technology platforms on the supply side or demand side of an ad stack.

Publishers and content providers often offer the same program channel with the same content programming and channel identifier, across multiple OEM platforms. For example, Ion Television offers channels, Ion, Ion Mystery, and others offer its services over more than one platform, including Samsung TV Plus, Roku Channel, Freebie, Fubo TV, and others.

Content is often repeated within such channels. For example, Ion Mystery repeats episodes of the show CSI Miami. Publishers such as Ion Television may utilize a streaming platform like Wurl or Amagi to deliver content. The content may optionally be delivered to a distribution platform referred to as a content distribution network (CDN). A content distribution network or content delivery network (CDN) is a network of proxy servers and their data centers. The goal is to provide high availability and performance by distributing the service, often spatially relative to end users. The streaming platforms provide channel guide information including channel identifier and program identification. The channel identifier may be the same for all streaming players (OEM platforms.) The CDNs or streaming platforms may run their own servers. According to an embodiment, the CDN or streaming platforms may establish advertising opportunities and may include at least a channel identifier in its ad opportunity.

A multimodal metadata extraction process may be utilized to generate a robust contextual index of the primary content, such as an episode of a program being delivered by a content provider. In this way, the content is indexed, and meta tags are created which are associated with the content. This enables a real-time lookup capability which may be used in an ad request process. Real-time is not required. It may be processed near-time or at some other time for later availability.

According to an embodiment, the content provider may set a channel identifier for a given channel using a configuration tool as part of a streaming platform electronic programming guide. Such tools are available with the services provided by Frequency Networks, Inc., Wurl LLC, and Amagi.

The channel identifier is included in the channel information in the EPG (Electronic Programming Guide) provided by a streaming platform like Wurl/Amagi/Frequency. The system receives that channel, which may be in the form of the EPG and HLS stream. Typically, the EPG contains what is currently playing along with at least 24 hours of future programming. The system then may receive the Channel Identifier for the channel, the EPG for the channel, the current time, and channel stream itself. If the current playing program is not yet in the system index, the system assigns a content ID, runs the contextual indexing process, and may store the Content ID, indexed time metatags, and time within the content. The contextual indexing process may be run on each scene or on each shot within the program and the time within the scene or shot may be stored.

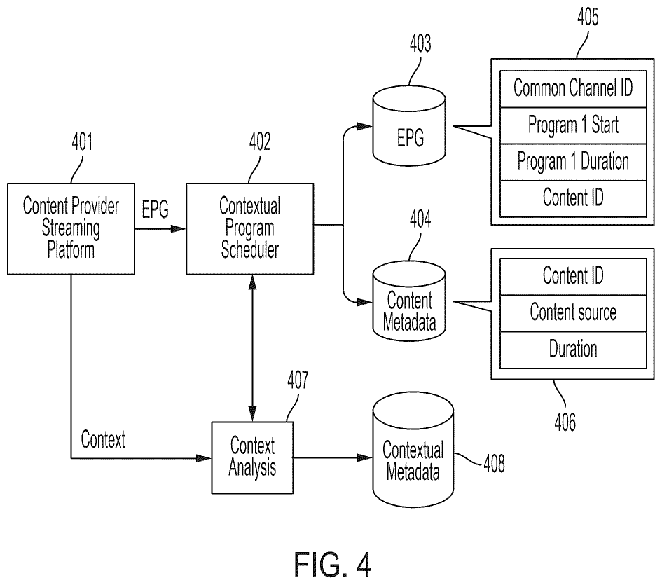

FIG. 4 shows the schematic of a contextual metadata extraction system that may be utilized for content ingestion. The content provider streaming platform 401 provides the electronic programming guide (EPG) information to program scheduler 402. The program scheduler 402 may query an electronic program guide database 403. The electronic program guide database 403 includes data 405 regarding the program being provided by the content provider streaming platform 401. Data 405 may include the common channel ID, for example, an identification corresponding to the content provider channel. Data 405 may also include program start time, program duration, and an assigned contextual content identification for a content program. The contextual content identification is uniquely assigned for each program content. The same contextual content identification is also used as an index for the content metadata for database 404. The content metadata database 404 includes data 406 which is indexed by contextual content ID, content source, and duration. and contextual metadata tags. If the contextual program scheduler 402 determines that the content metadata database 404 has no entry for the program content then the context analysis unit 407 is invoked. The contextual program scheduler 402 provides instructions to the context analysis unit 407 which processes the content, for example, by using a multimodal contextual metadata extraction process as shown in FIG. 1 to generate the contextual metadata which is provided to the contextual metadata database 408 and indexed by the contextual content ID. In addition, the content metadata database 404 is updated to indicate the availability of contextual metadata tags in the contextual metadata database 408. If there are preexisting contextual metadata tags, the content metadata database 404 will so indicated. If no contextual metadata is present in the content metadata database 408, then the contextual program scheduler initiates context analysis.

In this manner, the efficiencies can be realized for content that has already been processed and contextual metadata need not be extracted multiple times from the same content. Having contextual data facilitates enhancing the relevance of advertisement (secondary content) to be played with the user-selected program (primary content). The contextual data may be used in a demand-side process or may be used in a supply-side process.

In a demand-side process, the content provider may set a channel identifier for a given channel using the Wurl/Amagi/Frequency configuration tool. The content may be played at the scheduled time, on an OEM device, from the content streaming platform (Wurl/Amagi/Frequency). The channel identifier is passed through during playback via the OEM platform itself i.e., Samsung, Plus TV or The Roku Channel do not modify the channel identifier.

When a break occurs in the content, an ad request is sent from the streaming and supply side platform. The DSP receives the ad request including the channel identifier. The DSP may include or use logic to leverage the contextual metadata in real-time based on the context metadata database 404. The DSP then processes the bid request using the context tags retrieved from the context metadata database 404.

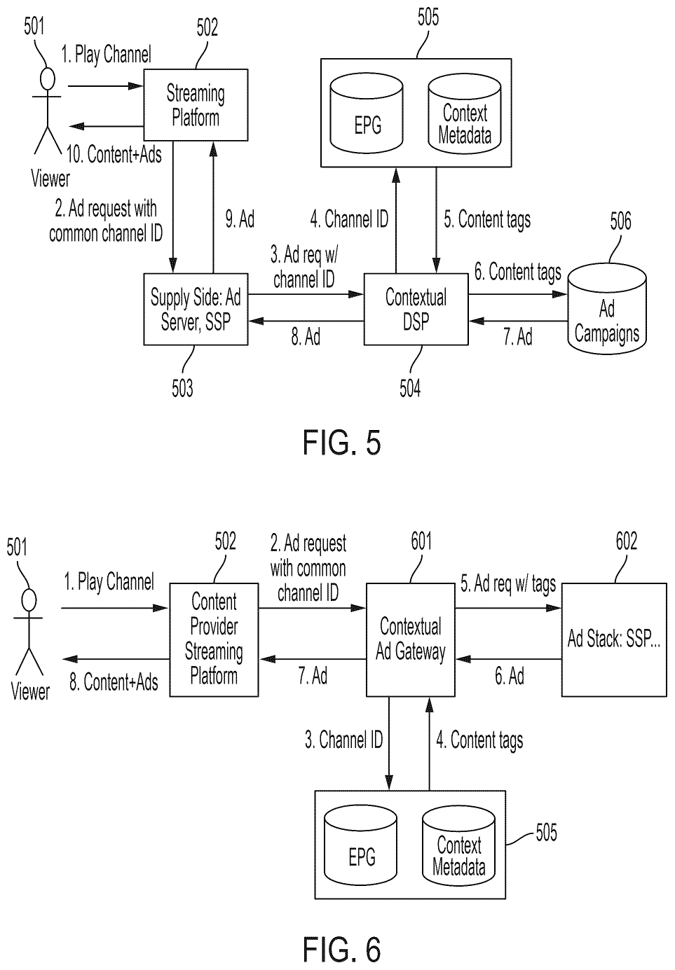

FIG. 5 shows a schematic of the system delivering program content which utilizes a contextual demand side platform. A viewer 501 may interact with a streaming platform 502 to initiate the display of content for consumption. The streaming platform may be integrated into a television or other display device or may be a stand-alone streaming device with an output connected to a display device. For example, Samsung televisions may include an integrated Samsung TV player activated through the television remote control. When a user selects the program guide function on a remote control, a Samsung TV Plus interface is displayed and the user may navigate to a selected program. The television may also be configured so that on power on, the same interface is displayed for a period of time. The display may default to the prior selected channel and may allow a user to browse the program guide, or enter the known channel number to select that content. Other device configurations function in a similar manner but may be based on an auxiliary device such as an Amazon TV Fire stick, or a Roku streaming platform.

The streaming platform 502, whether stand-alone or integrated into a display accepts control instructions and provides selected content (primary and secondary) to a display device. A supply-side ad server 503 supplies content to the streaming platform. The supply-side ad server 503 may be configured to recognize advertising opportunities in streaming content and upon recognition of such advertising opportunities, may issue an ad request to one or more demand-side platforms. Advertiser's agencies and service providers may operate such demand-side platforms which may evaluate information obtained from the supply-side platform to make a bid decision for evaluation by the supply-side ad server 503. The supply side ad server 503 evaluates the bids it receives and awards an ad slot based on its bid award logic. The successful demand-side platform is informed of the award and returns either the ad for placement or sufficient information for the supply-side platform to obtain the ad for placement.

In the demand side platform according to the described embodiment, contextual information is leveraged in its bid-forming logic. The demand side platform 504 receives the ad request information along with sufficient information to identify the content and time-stamped within the content program. The contextual demand-side platform 504 then accesses its contextual database 505 to access contextual metadata regarding the content to be used in its bid-forming logic for establishing a bid and selection of an advertisement. In this context, the selection of an advertisement is meant to include the selection of an ad creative, the selection of a campaign, and/or the selection of an ad creative within a campaign. The contextual demand-side platform 504 issues its bid to the supply-side ad server 503. If the bid is successful, the supply-side platform may issue its award back to the DSP 504 which may then deliver the ad from the ad campaign database 506 or deliver sufficient information for the supply-side platform to retrieve the ad from the ad campaign 506.

According to an alternative embodiment, the contextual metadata may be incorporated in a supply-side platform which makes contextual data available to demand-side platforms operated by others.

FIG. 6 shows a contextual ad gateway integrated into a supply-side platform. In this configuration, the content provider sets a channel identifier for a given channel using the Wurl/Amagi/Frequency configuration tool. The content is played at the scheduled time on a streaming player, for example, an OEM device, from the content streaming platform (Wurl/Amagi/Frequency). The content provider streaming platform 502 streams content to streaming players (not shown) controlled by viewers 501. The streams may be distributed to the streaming players or optionally through a content distribution network (not shown) and/or through the Internet or other networks. A channel identifier is passed through during playback via the streaming platform and the streaming players i.e., Samsung TV Plus or Roku. The content provider streaming platform may generate an ad request which is passed to the Contextual Ad Gateway 601, which receives the ad request including the channel identifier.

The Contextual Ad Gateway 601 may leverage the real-time lookup capability during Ad Request Flow. The contextual meta tags recorded in the previous phase are retrieved and added to the ad request. This ad request, with the contextual tags, is broadcast to the rest of the ad ecosystem, including all other DSPs (like TradeDesk, etc.). Buyers can buy based on the key value pair they wish to target. For example, the system may consider future EPG information and identify content ID to be repeated and be able to perform the context analysis to make the program's contextual metadata available for use on demand. In this way, the system may determine program will be streamed in an upcoming time slot. The system may access the program and extract the contextual metadata which will be stored and made available at the time that the program is being streamed over an OEM platform.

In the embodiment illustrated in FIG. 6, the viewer 501 and content provider streaming platform 502 interact in the same way as described in connection with FIG. 5. The supply-side platform may include a Contextual Ad Gateway 601 and a supply-side ad stack platform 602. The supply side at stack platform 602 issues bid requests in the same fashion as described in connection with the supply side ad server 503, except that the information issued with the big requests may also include contextual information extracted by the Contextual Ad Gateway 601 from the contextual database 505. The supply-side ad stack platform 602 provides contextual information regarding the content to connected demand-side platforms. The demand side platforms may or may not utilize the contextual information keeping on their respective bid-forming logic. The supply side platform at least gives the connected demand side platforms the opportunity to present bids on the basis of ad relevance to the contextual information.

The techniques, processes, and apparatus described may be utilized to control the operation of any device and conserve the use of resources based on conditions detected or applicable to the device or otherwise made available for further processing.

The system is described in detail with respect to preferred embodiments, and it will now be apparent from the foregoing to those skilled in the art that changes and modifications may be made without departing from the invention in its broader aspects, and the invention, therefore, as defined in the claims, is intended to cover all such changes and modifications that fall within the true spirit of the invention.

Thus, specific apparatus for and methods of metadata extraction have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, utilized, or combined with other elements, components, or steps that are not expressly referenced.

1. A method for utilizing a deep understanding of content to select secondary content comprising:
issuing an aggregated embedding generated by multimodal metadata extraction from a primary content stream;
comparing said aggregated embedding to metadata corresponding to secondary content generated by multimodal metadata extraction from said secondary content; and
selecting secondary content based on said step of comparing said aggregated embedding to metadata corresponding to said secondary content.

2. The method according to claim 1 further comprising:
the steps of identifying an advertising opportunity in said primary content; and
issuing a bid request for said advertising opportunity wherein said bid request includes identification of said advertising opportunity and said aggregated embedding.

3. A content processing system comprising:
a program scheduler connected to a content streaming platform wherein said program scheduler receives electronic program guide information from said content streaming platform;
an electronic program guide database connected to said program scheduler containing channel identification program start time information and a content identification assigned by said program scheduler; and
a content metadata database containing content source information, content duration, and contextual information regarding said program including an aggregated embedding generated by multimodal metadata extraction from content of said program wherein said content source information, said content duration information and said contextual information are indexed by said content identification assigned by said program scheduler.

4. The content processing system according to claim 3 further comprising a context analysis unit for generating an aggregated embedding by multimodal metadata extraction having a content input connecting said program to said context analysis unit and having an output connected to said content metadata database and configured to store said aggregated embedding as said contextual metadata.

5. The content processing system according to claim 4 wherein said program scheduler is connected to activate said context analysis unit.

6. The content processing system according to claim 5 wherein said program scheduler is configured to activate said context analysis unit if it determines that said content metadata database does not have contextual metadata stored for a program identified by said electronic program guide information.

7. The content processing system according to claim 6 further comprising
a supply-side ad server connected to said content streaming platform wherein said supply-side server receives an advertisement request including a channel identification from said content streaming platform and provides an advertisement responsive to said advertisement request to said content streaming platform; and
a contextual advertisement server platform connected to said supply side server, wherein said contextual advertisement server platform receives an advertisement request including a channel identification from said supply side server, and said contextual advertisement server platform uses said channel identification to retrieve contextual metadata from said context metadata database.

8. The content processing system according to claim 7 further comprising a demand side advertisement server connected to said contextual advertisement server platform to receive contextual metadata for use in identifying a responsive advertisement and based on said contextual metadata.

9. The content processing system according to claim 8 wherein said contextual advertisement server platform is a supply-side platform.

10. The content processing system according to claim 8, wherein said contextual advertisement server platform is a demand-side platform.
